(19) United States
(12) Patent Application Publication
(10) Pub. No.: US 2006/0182083 A1
(43) Pub. Date: Aug. 17, 2006

(54) Secured virtual private network with mobile nodes

(76) Inventors: Junya Nakata, Ishikawa-ken (JP); Heikki Waris, Helsinki (FI)

Correspondence Address: HARRINGTON & SMITH, LLP, 4 RESEARCH DRIVE, SHELTON, CT, 06484-6212, US

(21) Appl. No.: 10/531,653

(22) PCT Filed: Oct. 17, 2002
(86) PCT No.: PCT/IB02/04295

§ 371 Date: Mar. 27, 2006

(51) Int. Cl. H04L 12/66

(52) U.S. Cl. 370/352; 370/395.52; 713/170; 370/401

(57) ABSTRACT

A security gateway connects an external portion of a virtual private network to an internal secured portion of the network. The gateway is arranged to identify automatically when a communication session exists between two mobile workstations both of which are connected in the external portion of the network. The mobile workstations are then enabled to communicate with each other without using the gateway as an intermediary. This communication can be secured. The route by which packets are transferred between the workstations may then be optimised.

Embodiments of the present invention relate to a virtual private network capable of having a plurality of mobile nodes, to the components of the network and to the methods and processes used within the network.

A Virtual Private Network (VPN) provides a network-like connection via a public network, such as the internet. Remote components of the VPN appear to a user as if they are physically connected via dedicated communication cables, when in fact the public network may form at least part of the connection between them.

As the VPN may use a public network, security measures must be taken to prevent unauthorised users hacking into the VPN. The Internet Engineering Task Force (IETF) has developed the Internet Protocol Security (IPsec) standard, which is suitable for securing the VPN. The IPsec standard specifies an extension to TCP/IP that utilizes data encryption and digital encryption technology to positively identify a user or network component. Implementation of IPsec, or an equivalent security protocol, on a VPN results in a Secure Virtual Private Network (SVPN).

A SVPN has a Security Gateway placed at the interface between a private secured network and the public unsecured network. The private secured network forms an internal portion of the VPN, whereas those parts of the VPN which are part of the public network are external portions of the VPN.

The SVPN is a packet switching network in which data is sent as packets. Each packet has a data payload and a header. The header includes the address of the origin of the data and the address of the destination of the data. The addresses used may be public IP addresses or private IP addresses. A public address is a globally unique address, whereas a private address is unique in the VPN but not necessarily globally.

A Security Association (SA) is a context defining a virtual simplex connection between two end points that affords security services to the traffic carried between those end points. To secure bidirectional communication between two nodes, two Security Associations (one in each direction) are required in both nodes. Among other things each context indicates an authentication and/or encryption algorithm and a secret (a shared key, or appropriate public/private key pair).

Each node has a Security Policy Database (SPD) and a Security Association Database (SAD). The SPD specifies the treatment of every inbound and outbound packet. It also indicates which SA or SA bundle in SAD should be used, if any. The SPD maps traffic to a SAD entry, which has the SA parameters for the traffic. The Encapsulating Security Payload (ESP) [RFC2406] is one type of Security Association and it provides confidentiality, data origin authentication, connectionless integrity, anti-replay service and limited traffic flow confidentiality.

MobileIPv6 (MIPv6) allows a mobile node (MN) to move from one link to another without changing the mobile node's IP address (Home Address). Thus a mobile node is always addressable by its Home Address (HoA).

The HoA is an IP address assigned, for an extended period of time, to the mobile node within its home network. It is a “static” identifier and therefore remains unchanged regardless of which link a mobile node uses to link to the network.

The home network has a network prefix matching that of a mobile node's HoA and packets destined for a mobile node's HoA will be delivered to the mobile node's Home Network. The mobile node may also be attached to other networks other than the home network, these are called Visited Networks.

The MN is able to maintain its static identifier (HoA) and communicate in Visited Networks by associating a dynamic identifier (Care-of-Address) with the static identifier (HoA) while moving outside its home network. The Care-of-Address (CoA) reflects the MN current point of attachment. The association of the HoA and CoA is stored in a Home Agent (HA) and correspondent nodes (CN) and is referred to as a “binding” or “mobility binding” when combined with the lifetime of the association.

The HA is a router in the home network which tunnels packets for delivery to the mobile node when it is away from the home network, and maintains current location information for the mobile node. The HA intercepts a packet sent to the HoA of the MN, encapsulates the intercepted packet using Type 2 Routing Header and sends it to the CoA of the MN. When the MN receives the packet in its CoA, it removes the Routing Header where the HoA was and forwards the packet internally to the HoA.

The mobile node generally uses its HoA as the end point of all its communications, and the CoA as the source address of all IP packets that it sends. These packets are delivered to their destination via normal IP routing mechanisms. Packets sent to the mobile node do not necessarily pass through the HA if the CoA is known to the correspondent node.

When the MN moves to a Visited Network, the MN detects this and obtains a CoA on the Visited network. It then sends a Binding Update to the HA and any correspondent node. A correspondent node is a mobile or stationary peer with which a mobile node is communicating. The Binding Update registers the new CoA of the MN.

MIPv6 provides for route optimisation via return routability and binding updates. The CoA is sent to the HA and to the CN, therefore CN messages can be routed directly to the CoA and need not go via the HA.

IPsec is mandatory for IPv6. In a combination of MIPv6 and IPsec, MIPv6 confirms the validity of the end points, and IPsec can be used for protecting the actual traffic between those end points. From the IPsec point of view, the SAs simply take place between two static addresses, the HoA of the MN and the regular address of the CN.

In a SVPN with mobile nodes, each MN has or creates two pairs of SAs, one with the SG and the other with its HA. The SVPN can be considered to have an internal portion which is connected to the public network via a Security Gateway (SG) and a external portion connected to and forming part of the public network.

If internal addressing is used, communication between a MN, which is in the external portion of the SVPN and any other node of the SVPN occurs via the SAs between the MN and the SG. Thus if one MN, e.g. MN1, which is in the external portion of the SVPN, is communicating with another MN, e.g. MN2, which is also in the external portion of the SVPN, then all communications between MN1 and MN2 will be via the SG using the SA pairs between MN1 and the SG and MN2 and the SG. There should not be direct communication between MN1 and MN2 via the public network because the internal addresses are ambiguous (not globally unique) and therefore traffic using them is not properly routable in the public network and also because security could be compromised. This results in inefficient routing.

If external addressing is used, communication between one MN, e.g. MN1, which is in the external portion of the SVPN, and another MN, e.g. MN2, which is also in the external portion of the SVPN, can be directly between MN1 and MN2 after they exchange return routability and binding messages. This provides for efficient but insecure communication unless a pair of up-to-date SAs between MN1 and MN2 already exists in both nodes.

It would be desirable to improve secure virtual private networks having mobile nodes by providing efficient and secure routing for communications between mobile nodes of the network.

According to first aspect of the present invention there is provided a gateway for connecting an external portion of a network to an internal secured portion of the network wherein the gateway is arranged to identify automatically when a communication session exists between two mobile workstations both of which are connected in the external portion of the network.

Embodiments of this aspect of the invention provide for detection of when two mobile workstations (MN1 & MN2) are communicating via the gateway (SG). This detection may, in embodiments of the invention, initiate a mechanism that allows the mobile workstations to communicate without using the gateway as an intermediary. This, in turn, allows the route by which-packets are transferred between the first mobile workstation (MN1) and the second mobile workstation (MN2) to be optimised.

According to another aspect of the invention there is provided a network including an internal secured portion which connects, via a gateway to an external portion, the network comprising a plurality of workstations including mobile workstations; the gateway and secure communication means by which information is transferable securely to a first mobile workstation in the external portion of the network via the gateway and by which information is transferable securely to a second mobile workstation in the external portion of the network via the gateway; and information transfer means located within the internal secured portion of the network or within the gateway and arranged to send, using the secure communication means, an identifier of the second mobile workstation to the first mobile workstation for use as an address in a packet originating from the first mobile workstation and destined for the second mobile workstation.

Embodiments of this aspect of the invention provide an identifier of the second mobile workstation (MN2) securely to the first mobile workstation (MN1). This identifier may allow the first mobile workstation (MN1) to communicate with the second mobile workstation (MN2) without using the gateway (SG) as an intermediary. This, in turn, allows the route by which packets are transferred between the first mobile workstation (MN1) and the second mobile workstation (MN2) to be optimised. The identifier may be the external Home Address of the second mobile workstation (MN2).

According to a further aspect of the present invention there is provided a virtual private network including an internal secured portion which connects, via a gateway to an external portion, the network being arranged to communicate within the internal portion of the network using private addresses and comprising: a plurality of workstations including mobile workstations; the gateway; first secure communication means by which information is transferable securely to a first mobile workstation connected at the external portion of the network via the gateway and by which information is transferable securely to a second mobile workstation connected at the external portion of the network via the gateway; and information transfer means arranged to send first security information to the first mobile workstation and second security information to the second mobile workstation using the first secure communication means, wherein the first mobile workstation uses the first security information and the second mobile workstation uses the second security information to enable a second secure communication means by which further information is transferable securely between the first mobile workstation and the second mobile workstation without passing through the gateway.

Embodiments of this aspect of the invention provide, perhaps different, security information to the first mobile workstation (MN1) and the second mobile workstation (MN2) which enables secure communications between the first and second mobile workstations without having to use the gateway as an intermediary to secure communications.

According to a still further aspect of the present invention there is provided a virtual private network including an internal secured portion which connects, via a gateway to an external portion, the network being arranged to communicate within the internal portion of the network using private addresses and comprising: a plurality of workstations including mobile workstations; the gateway; secure communication means by which information is transferable securely, without passing through the gateway, between a first mobile workstation connected to the external portion of the network and a second mobile workstation connected to the external portion of the network; means for dynamically updating an identifier of the first mobile workstation as it moves within the external portion of the network; means for communicating the updated identifier of the first mobile workstation to the second mobile workstation; and means for sending packets from the second mobile workstation to the first mobile workstation using the secure communication means, wherein the packets are addressed using the updated identifier of the first mobile workstation and are routed without necessarily passing through the gateway.

Embodiments of this aspect of the invention provide for secure communications between the first and second mobile workstations without being forced to use the gateway as an intermediary to secure communications. This allows the route by which packets are transferred between the first mobile workstation (MN1) and the second mobile workstation (MN2) to be optimised.

For a better understanding of the present invention and to understand how the same may be brought into effect reference will now be made by way of example only to the accompanying drawings illustrating embodiments of the invention:

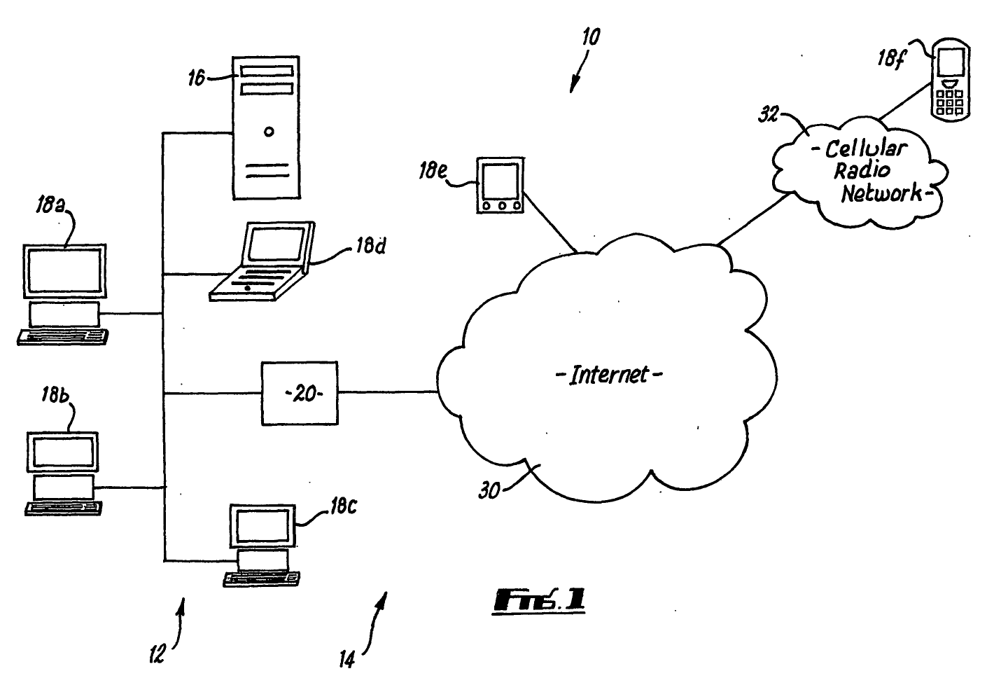

FIG. 1 is a schematic illustration of a secure virtual private network (SVPN) according to one embodiment of the invention; and

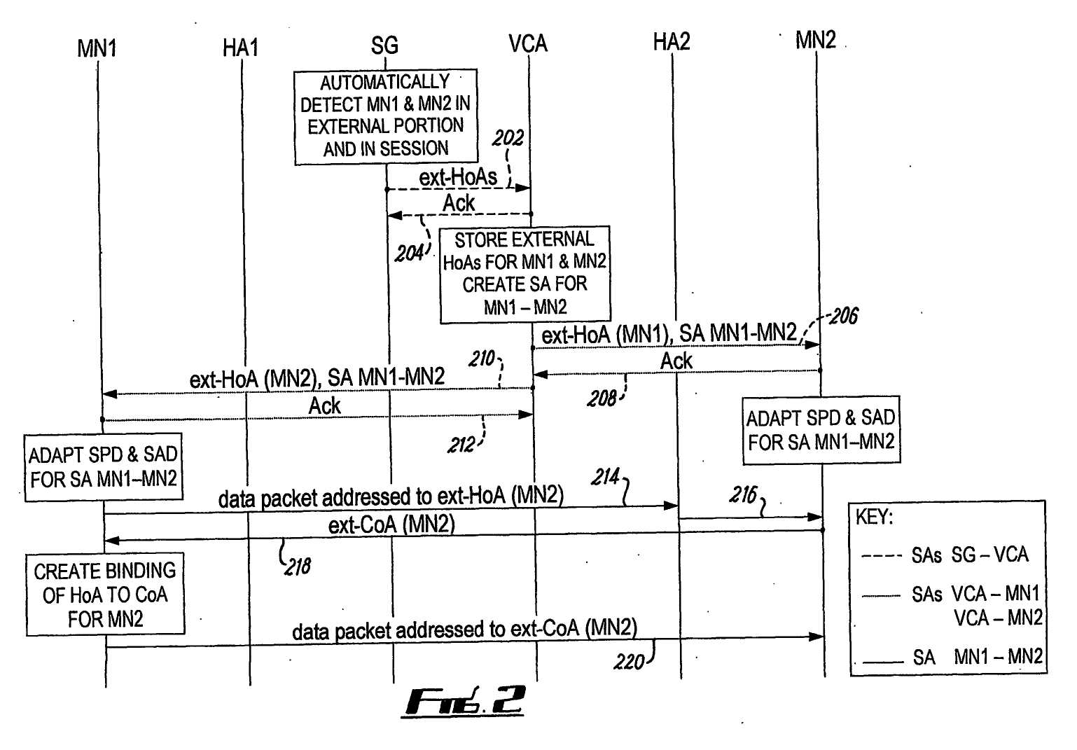

FIG. 2 is a signalling diagram of a secure virtual private network (SVPN) in which two mobile nodes, MN1 & MN2, move into an external portion of the SVPN while communicating with each other.

The virtual private network (VPN) 10, comprises an internal portion 12 which is protected by a firewall or Security Gateway (SG) 20 and an external portion 14 which uses an unsecured communications medium 30, such as the internet, to communicate with the internal portion 12 via the Security Gateway 20.

The VPN 10 has a file server 16 and a plurality of client workstations 18a, 18b, 18c, 18d, 18e and 18f. The workstations 18a, 18b and 18c are desktop machines within the internal portion 12 of the VPN 10 and are non-mobile nodes of the VPN 10. The workstation 18d is a portable machine, in this case a laptop computer, which is a mobile node (MN) of the VPN 10. The workstation 18d is currently physically located within the internal portion 12. The workstation 18e is a portable machine (a hand-portable personal digital assistant), which is a mobile node MN1 of the VPN. The portable workstation 18e is currently physically located in the external portion 14 of the VPN and connected to the gateway 20 via the unsecured communications medium 30. The workstation 18f is a portable machine (a hand-portable cellular radio telephone), which is a mobile node MN2 of the VPN. The portable workstation is currently physically located in the external portion 14 of the VPN and is connected to the gateway 20 via a cellular radio telephone network 32 and then the unsecured communications medium 30.

The VPN 10 has a router 22, which provides the functionality of the HA of the mobile nodes of the VPN 10. The file sever 16, the Security Gateway 20, the router 22 or some other intelligence within the internal portion 12 of the VPN may provide the functionality of the VPN Connectivity Manager (VCM), which is described in more detail below.

### Embodiment 1

This embodiment relates to a Virtual Private Network (VPN) which uses private (not public) addresses. In the following description reference will be made to FIG. 2.

The first mobile node MN1 has a pair of SAs (uplink and downlink) with the Security Gateway (SG) and another pair of SAs (uplink and downlink) with a VPN Connectivity Manager (VCM). The second mobile node MN2 has a pair of SAs (uplink and downlink) with the Security Gateway (SG) and another pair of SAs (uplink and downlink) with a VPN Connectivity Manager (VCM). The SG has three pairs of SAs (uplink and downlink), one pair with MN1, one pair with MN2 and the other pair with the VCM. The VCM has three pairs of SAs (uplink and downlink), one pair with MN1, one pair with MN2 and the other pair with SG.

A mobile node (MN), Security Association (SA), Home Agent (HA), Security Gateway (SG) are terms well understood by a person knowledgeable in Virtual Private Networks, Internet Protocol Security (IPsec) Protocol and Mobile Internet Protocol version 6 (MIPv6).

The VPN Connectivity Manager (VCM) is a newly devised component of a VPN and the Security Associations between the VCM and MN1 and MN2 are newly implemented Security Associations. The Security Association between a MN and the VCM is an Encapsulating Security Payload (ESP) SA and utilizes internal addresses of the VPN.

The Security Association between the Security Gateway (SG) and the mobile nodes utilizes the external, public HoA of the MNs as opposed to the is VPN internal address.

Let us assume that there is an existing session between MN1 and MN2 and that MN2 has previously entered the external portion of the VPN.

When MN2 exited the internal portion, of the VPN and entered the external portion of the VPN, at least one of the uplink and downlink SAs between MN2 and the SG became active.

This activation took place as a result of the following process. Inside the internal portion of the VPN, either the inbound SPD was receiving only packets with addresses used inside the VPN and/or the MIPv6 binding update list had only bindings with addresses used inside the VPN. When MN2 moved to the external portion of the VPN, the SPD started receiving packets with non-VPN addresses and/or the MIPv6 binding update list had also bindings with non-VPN addresses. Because of these changes, MN2 detected the movement to the external portion of the VPN. At that point, it changed the SPD policy for inbound VPN traffic from “no IPsec” into “use IPsec with default SG→MN2 ESP SA”, and it changed the SPD policy for outbound VPN traffic from “no IPsec” into “use IPsec with default MN2→SG ESP SA”.

In order to avoid attacks where the attacker sets up a fake network where the same addresses are used as inside the VPN, additional SAs may be enforced by the VPN owner to authenticate the messages, e.g. Router Advertisements, sent by nodes in the internal portion of the VPN. In this case, after a change of link, MN would always assume that it is in the external portion of the VPN unless its SPD receives such a packet and the SA processing confirms the authentication (using e.g. an existing Authentication Header (AH) SA between the internal node and MN2).

The inbound SA in SG is always active, and the outbound SA is activated when the inbound SPD receives packets from MN2's external HoA and/or the MIPv6 binding cache has a binding with MN2's external HoA.

If necessary, MN2 executes a Binding Update with the SG. Therefore the SG maps the external HoA of MN2 to the external CoA of MN2 and sends packets for the MN2 to the external CoA of MN2.

The SG is an intermediate node in communications from and to MN2 using private addresses. It monitors the headers of these communications and stores in a cache the internal addresses of the CNs with which MN2 communicates. The packets addressed to or sent by MN2 can be identified from the HoA or current CoA of MN2 in the headers.

The SG sends a message 202 to the VCM with MN2's external HoA. The VCM receives the external HoA and stores it in its MN context database. The MN context comprises the MN internal HoA, the MN external HoA, the internal HoAs of correspondent nodes of the MN, and details of the managed SAs with identification of the relevant secrets and algorithms. The VCM may send an Acknowledgement message 204 to the SG.

When MN1 exits the internal portion of the VPN and enters the external portion of the VPN, at least one of the uplink and downlink SAs between MN1 and the SG becomes active.

If necessary, MN1 executes a Binding Update with the SG. Therefore the SG maps the external HoA of MN2 to the external CoA of MN1 and sends packets for the MN1 to the external CoA of MN1.

The SG is an intermediate node in communications from and to MN1 using private addresses. It monitors the headers of these communications and stores in a cache the internal addresses of the CNs with which MN1 communicates. The packets addressed to or sent by MN1 can be identified from the HoA or current CoA of MN1 in the header.

The SG sends a message 202 to the VCM with MN1's external HoA.

The VCM receives the external HoA and stores it in its MN context database. The MN context comprises the MN internal. HoA, the MN external HoA, the internal HoAs of correspondent nodes of the MN, and details of the managed SAs with identification of the relevant secrets and algorithms. The VCM may send an Acknowledgement message 204 to the SG.

The SG also detects that MN1 and MN2 are involved in a session. The SG has a binding with MN1, if necessary, and therefore stores information relating the static identifier (HoA) and dynamic identifier (CoA) of MN1. Thus all packets sent by or to MN1 can be identified. The SG has a binding with MN2, if necessary, and therefore stores information relating the static identifier (HoA) and dynamic identifier (CoA) of MN2. Thus all packets sent by or to MN2 can be identified. The SG detects that MN1 and MN2 are in a session by detecting when a packet is sent from MN1 to MN2 or a packet is sent from MN2 to MN1.

The SG sends a message 202 to the VCM indicating that MN1 and MN2 are having a session. This session indication message could be combined with or be separate from the message informing the VCM of the external HoA of MN1.

VCM receives the MN1-MN2 session indication message and may send an Acknowledgement message 204 to the SG. In response to this message, the VCM creates information for an SA pair for MN1-MN2 communication. It generates random secrets and stores them in the MN context database in the VCM for the MN1-MN2 session. In a preferred implementation the secrets are keys the number and length of which depend on the implementation, and are accompanied by other SA material such as algorithm definition.

The VCM sends 206 a first secret(s) defining the SA pair between MN1 and MN2 and the external HoA of MN1 to MN2 via its (internal) ESP SA with MN1. Thus there will be end-to-end security between the VCM and the internal address of the MN1. The VCM separately sends 210 a second secret(s) defining the SA pair between MN1 and MN2 and the external HoA of MN2 to MN1 via its (internal) ESP SA with MN2. Thus there will be end-to-end security between the VCM and the internal address of the MN2.

The MN1 receives the secret(s) and the external HoA of MN2. It enters into its Security Association Database (SAD) a new ESP SA to the MN2 and a new ESP SA from the MN2. Each entry specifies the algorithm to be used and the secret(s) to be used. The MN1 modifies its Security Policy Database (SPD) so that traffic destined for MN2 will be encrypted using one of the new SA pair and traffic from MN2 will be decrypted using the other one of the new SA pair. After first modifying the inbound SPD policy (traffic from MN2), MN1 sends an Acknowledgement message 212 to the VCM which forwards it to MN2. The outbound SPD policy (traffic destined for MN2) is only modified after the reception of Acknowledgement message 208 from MN2 via VCM. This ensures that MN2 can decrypt the packets when they are sent by MN1.

The MN2 receives the secret(s) and the external HoA of MN1. It enters into its Security Association Database (SAD) a new ESP SA to the MN1 and a new ESP SA from the MN1. Each entry specifies the algorithm to be used and the secret(s) to be used. The MN2 modifies its Security Policy Database (SPD) so that traffic destined for MN1 will be encrypted using one of the new SA pair and traffic from MN1 will be decrypted using the other one of the new SA pair. After first modifying the inbound SPD policy (traffic from MN1), MN2 sends an Acknowledgement message 208 to the VCM which forwards it to MN1. The outbound SPD policy (traffic destined for MN1) is only modified after the reception of Acknowledgement message 212 from MN1 via VCM. This ensures that MN1 can decrypt the packets when they are sent by MN2.

The new ESP SAs provide for end-to-end encryption between the external HoA of MN1 and the external HoA of MN2. The packets with internal addresses are exchanged in the crypto tunnel between the external HoAs.

The MN1 uses the external HoA address to route packets to MN2. When MN1 first sends a packet 214 encrypted by the new ESP SA to the external HoA of MN2, it first goes to the external HA of MN2 which forwards 216 it to the external CoA of MN2. After this the return routability and binding process between the MN1 and MN2 provides 218 the external CoA of MN2 to MN1. MN1 uses the external CoA of MN2 to address packets 220 destined for MN2.

The MN2 uses the external HoA address to route packets to MN1. When MN2 first sends packets encrypted by the new ESP SA to the external HoA of MN1, they first go to the external HA of MN1 which forwards them to the external CoA of MN1. After this the return routability and binding process between the MN2 and MN1 provides the external CoA of MN1 to MN2. MN2 uses the external CoA of MN1 to address packets destined for MN1.

The return routability and binding process optimises the route between the MN1 and MN2 external CoAs and continues to do so as long as both MNs are outside the private network, without SG or VCM intervention. When either MN1 or MN2 moves to a different point of attachment in the external portion of the VPN a handover procedure occurs to the new point of attachment. The procedure is specified by MIPv6. If MN1 moves, the CoA of MN1 changes and this change is automatically communicated to MN2. Thus the route between MN1 and MN2 remains optimised.

When either MN returns to the private network, the SA between that MN and the SG, which was used for communication between that MN and the interior of the VPN, no longer receives packets. This is because the MN is now in the internal portion of the VPN and starts to send packets unencrypted within the private network. This movement from the external portion of the VPN to the internal portion of the VPN is detected in the same way as the movement from the internal portion of the VPN to the external portion of the VPN (but vice versa) by the SG which then informs the VCM. The VCM commands the remaining external MN to amend its SAD and/or SPD so that it uses its ESP SA with the SG again for communication with the internal MN.

### Embodiment 2

This embodiment relates to a VPN which uses public (not private) addresses, such as IP addresses. In the following description reference will be made to FIG. 2.

The first mobile node MN1 has a pair of SAs (uplink and downlink) with the Security Gateway (SG) and another pair of SAs (uplink and downlink) with a VPN Connectivity Manager (VCM). The second mobile node MN2 has a pair of SAs (uplink and downlink) with the Security Gateway (SG) and another pair of SAs (uplink and downlink) with a VPN Connectivity Manager (VCM). The SG has three pairs of SAs (uplink and downlink), one pair with MN1, one pair with MN2 and the other pair with the VCM. The VCM has three pairs of SAs (uplink and downlink), one pair with MN1, one pair with MN2 and the other pair with SG.

The SAs between the Security Gateway (SG) and the mobile nodes utilize the external, public HoA of the MNs as opposed to VPN internal addresses, which were used in embodiment 1 but represent only a subset of public addresses in this embodiment.

The SAs between a MN and the VCM is an Encapsulating Security Payload (ESP) SA and is encapsulated inside the Security Association between the SG and the MN.

Let us assume that there is an existing session between MN1 and MN2 and that MN2 has previously entered the external portion of the VPN.

When MN2 exited the internal portion of the VPN and entered the external portion of the VPN, at least one of the uplink and downlink SAs between MN2 and the SG became active. This process is the same as that described in relation to embodiment 1.

If necessary, MN2 executes a Binding Update with the SG. Therefore the SG maps the HoA of MN2 to the CoA of MN2 and sends packets for the MN2 to the CoA of MN2.

The SG is an intermediate node in communications between the internal portion of the VPN and MN2. It monitors the headers of these communications and stores in a cache the addresses of the CNs with which MN2 communicates. The packets addressed to or sent by MN2 can be identified from the HoA or current CoA of MN2 in the headers.

The SG sends a message 202 to the VCM with MN2's HoA. The VCM receives the HoA and stores it in its MN context database. The MN context comprises the MN HoA, the HoAs of the correspondent nodes of the MN, and details of the managed SAs with identification of the relevant secrets and algorithms. The VCM may send an Acknowledgement message 204 to the SG.

When MN1 exits the internal portion of the VPN and enters the external portion of the VPN, at least one of the uplink and downlink SAs between MN1 and the SG becomes active.

If necessary, MN1 executes a Binding Update with the SG. Therefore the SG maps the HoA of MN2 to the CoA of MN1 and sends packets for the MN1 to the CoA of MN1.

The SG is an intermediate node in communications between the internal portion of the VPN and MN1. It monitors the headers of these communications and stores in a cache the addresses of the CNs with which MN1 communicates. The packets addressed to or sent by MN1 can be identified from the HoA or current CoA of MN1 in the header.

The SG sends a message 202 to the VCM with MN1's HoA.

The VCM receives the HoA and stores it in its MN context database. The MN context comprises the MN HoA, the HoAs of the correspondent nodes of the MN, and details of the managed SAs with identification of the relevant secrets and algorithms. The VCM may send an Acknowledgement message 204 to the SG.

The SG also detects that MN1 and MN2 are involved in a session. The SG has a binding with MN1, if necessary, and therefore stores information relating the static identifier (HoA) and dynamic identifier (CoA) of MN1. Thus all packets sent by or to MN1 can be identified. The SG has a binding with MN2, if necessary, and therefore stores information relating the static identifier (HoA) and dynamic identifier (CoA) of MN2. Thus all packets sent by or to MN2 can be identified. The SG detects that MN1 and MN2 are in a session by detecting when a packet is sent from MN1 to MN2 or a packet is sent from MN2 to MN1.

The SG sends a message 202 to the VCM indicating that MN1 and MN2 are having a session. This session indication message could be combined with or be separate from the message informing the VCM of the external HoA of MN1.

VCM receives the MN1-MN2 session indication message and may send an Acknowledgement message 204 to the SG. In response to this message, the VCM creates information for an SA pair for MN1-MN2 communications. It generates random secrets and stores them in the MN context database in the VCM for the MN1-MN2 session. In a preferred implementation the secrets are keys the number and length of which depend on the implementation, and are accompanied by other SA material such as algorithm definition.

The VCM sends 206 a first secret(s) defining the SA pair between MN1 and MN2 and the HoA of MN1 to MN2 via its (encapsulated) ESP SA with MN1. Thus there will be end-to-end security between the VCM and the MN1. The VCM separately sends 210 a second secret(s) defining the SA pair between MN1 and MN2 and the HoA of MN2 to MN1 via its (encapsulated) ESP SA with MN2. Thus there will be end-to-end security between the VCM and MN2. Because both the MNs and the VCM are using public addresses, the SAs between them could also be direct. The encapsulation of those inner SAs inside the outer SAs between the MNs and the SG is not necessary, but when used, improves overall security.

The MN1 receives the secretes) and the external HoA of MN2. It enters into its Security Association Database (SAD) a new ESP SA to MN2 and a new ESP SA from MN2. Each entry specifies the algorithm to be used and the secret(s) to be used. The MN1 modifies its Security Policy Database (SPD) so that traffic destined for MN2 will be encrypted using one of the new SA pair, and traffic from MN2 will be decrypted using the other one of the new SA pair. After first modifying the inbound SPD policy (traffic from MN2), MN1 sends an Acknowledgement message 212 to the VCM which forwards it to MN2. The outbound SPD policy (traffic destined for MN2) is only modified after the reception of Acknowledgement message 208 from MN2 via VCM. This ensures that MN2 can decrypt the packets when they are sent by MN1.

The MN2 receives the secret(s) and the HoA of MN1. It enters into its Security Association Database (SAD) a new ESP SA to the MN1 and a new ESP SA from the MN1. Each entry specifies the algorithm to be used and the secret(s) to be used. The MN2 modifies its Security Policy Database (SPD) so that traffic destined for MN1 will be encrypted using one of the new SA pair, and traffic from MN1 will be decrypted using the other one of the new SA pair. After first modifying the inbound SPD policy (traffic from MN1), MN2 sends an Acknowledgement message 208 to the VCM which forwards it to MN1. The outbound SPD policy (traffic destined for MN1) is only modified after the reception of Acknowledgement message 212 from MN1 via VCM. This ensures that MN1 can decrypt the packets when they are sent by MN2.

The HoA received in the message from the VCM is in this embodiment not necessarily used in route optimization between two nodes that already have a session in the external portion of the VPN (because MIPv6 may be used to provide the HoA directly). Instead, it is used for modification of the appropriate SAD entries using the new secret(s), or for securely setting up an SA between the HoAs by utilizing the existing SAs with SG and VCM, or for avoiding the unnecessary default use of direct SAs when MNs are in the internal portion of the VPN.

The new ESP SAs provide for end-to-end encryption between the HoA of MN1 and the HoA of MN2.

The MN1 uses the HoA address to route packets to MN2. When MN1 first sends packet 214 encrypted by the new ESP SA to the HoA of MN2, it first goes to the HA of MN2 which forwards 216 it to the CoA of MN2. After this the return routability and binding process between the MN1 and MN2 provides 218 the CoA of MN2 to MN1. MN1 uses the CoA of MN2 to address packets 220 destined for MN2.

The MN2 uses the HoA address to route packets to MN1. When MN2 first sends packets encrypted by the new ESP SA to the HoA of MN1, they first go to the HA of MN1 which forwards them to the CoA of MN1. After this the return routability and binding process between the MN2 and MN1 provides the CoA of MN1 to MN2. MN2 uses the CoA of MN1 to address packets destined for MN1.

The return routability and binding process optimises the route between the MN1 and MN2 CoAs and continues to do so as long as the MNs have a session, whether they are in the interior or exterior portion of the VPN, without SG or VCM intervention. When either MN1 or MN2 moves to a different point of attachment in the external portion of the VPN a handover procedure occurs to the new point of attachment. The procedure is specified by MIPv6. If MN1 moves, the CoA of MN1 changes and this change is automatically communicated to MN2. Thus the route between MN1 and MN2 remains optimised.

When either MN returns to the private network, the SA between that MN and the SG, which was used for communication between that MN and the interior of the VPN, no longer receives packets. This is because the MN is now in the internal portion of the VPN and starts to send packets unencrypted within the private network. This movement from the external portion of the VPN to the internal portion of the VPN is detected in the same way as the movement from the internal portion of the VPN to the external portion of the VPN (but vice versa) by the SG which then informs the VCM. The VCM commands the remaining external MN to amend its SAD and/or SPD so that it uses its ESP SA with the SG again for communication with the internal MN.

The external HA need not be trusted because the existing SAs with SG and VCM guarantee that the exchanged SA secrets defining the SA between MN1 and MN2 cannot be spoofed.

General

The following may relate to any and all embodiments.

The first and second secret(s) may be symmetric keys for encryption and decryption. The same key being used for encryption and decryption in both MNs or separate keys may be used for encryption/decryption in one MN and used for corresponding decryption/encryption in the other MN. Alternatively, the secret(s) may be asymmetric keys such as public and private keys.

The preceding description has described a VCM as a separate entity to the SG. This provides some advantages, in that an existing VPN can be modified by the addition of a physical VCM. This provides backwards compatibility. When the VCM is a separate entity from the SG it is necessary for it to have pre-existing SAs with the MNs.

In another implementation, the functions of the VCM are incorporated into the SG and there is no physical VCM. This has the advantage of reducing the number of VPN entities but necessitates modification of the SG. This implementation is not necessarily backwards compatible with an existing SG, although it may be effected as a software update to an existing SG. When the VCM is part of the SG there will not be separate SAs from the VCM to the MNs. The VCM will use the SAs of the SG to the MNs.

The implementation of embodiments of the invention therefore require a modification to the internal VPN by the introduction of the functionality of the VCM and a modification to mobile nodes and to SGs.

In the above described embodiments, the session already existed between MN1 and MN2 before both MN1 and MN2 were in the external portion of the VPN. Thus the trigger was the detection of an existing session between two ‘external’ MNs. This triggered the process of creating an new SA, using an existing SA, between the two ‘external’ MNs.

An alternative or additional trigger is the detection of both:
a) that a VPN node initiating a data transfer session is an ‘external’ node, and
b) that the destination node of the data transfer is an ‘external’ node.
This triggers the process of creating a new SA, using an existing SA, between the two ‘external’ nodes.

The skilled reader will understand that in this document the term ‘Security Association’ may at times refer to a unidirectional Security Association, a pair of unidirectional (inbound & outbound) Security Associations and the information stored to effect these Security Associations.

Although two-way communications have been described between MN1 and MN2, in alternative embodiments of the invention there is only one-way, not two-way, traffic e.g. from MN1 to MN2 or from MN2 to MN1. Thus, MN1/MN2 may be a source and destination of data, a source only or a destination only.

Whilst endeavouring in the foregoing specification to draw attention to those features of the invention believed to be of particular importance it should be understood that the Applicant claims protection in respect of any patentable feature or combination of features hereinbefore described, referred to and/or shown in the drawings, whether or not particular emphasis has been placed thereon.

1. A gateway for connecting an external portion of a network to an internal secured portion of the network wherein the gateway is arranged to identify automatically when a communication session exists between two mobile workstations both of which are connected in the external portion of the network.

2. A gateway as claimed in claim 1, having means for monitoring the source and destination of received packets.

3. A gateway as claimed in claim 1 having secure communication means by which information is transferable securely to the two mobile workstations separately.

4. A gateway as claimed in claim 3 wherein the secure communication means includes a first Security Association with a first mobile workstation and a second Security Association with a second mobile workstation.

5. A gateway as claimed in claim 3, wherein the gateway is arranged to send, using the secure communication means, an identifier of a second mobile workstation to a first mobile workstation for use as an address in a packet originating from the first mobile workstation and destined for the second mobile workstation

6. A gateway as claimed in claim 5 wherein the identifier of the second mobile workstation is a Home Address.

7. A gateway as claimed in claim 3, wherein the gateway is arranged to send, using the secure communication means, an identifier of the first mobile workstation to the second mobile workstation for use as an address in a packet originating from the second mobile workstation and destined for the first mobile workstation.

8. A gateway as claimed in claim 7 wherein the identifier of the first mobile workstation is a Home Address.

9. A gateway as claimed in claim 3, wherein the gateway is arranged to send first security information to the first mobile workstation and second security information to the second mobile workstation using the secure communication means, wherein the first mobile workstation uses the first security information and the second mobile workstation uses the second security information to enable a second secure communication means by which further information is transferable securely between the first mobile workstation and the second mobile workstation without passing through the gateway.

10. A gateway as claimed in claim 9, wherein the second secure communication means comprises Security Associations.

11. A gateway as claimed in claim 1 wherein the gateway is further arranged to identify automatically when a mobile workstation moves between the internal and the external portions of the network.

12. A network including an internal secured portion which connects, via a gateway to an external portion, the network comprising a plurality of workstations including mobile workstations; the gateway and secure communication means by which information is transferable securely to a first mobile workstation in the external portion of the network via the gateway and by which information is transferable securely to a second mobile workstation in the external portion of the network via the gateway; and information transfer means located within the internal secured portion of the network or within the gateway and arranged to send, using the secure communication means, an identifier of the second mobile workstation to the first mobile workstation for use as an address in a packet originating from the first mobile workstation and destined for the second mobile workstation.

13. A network as claimed in claim 12, wherein the information transfer means is further arranged to send, using the secure communication means, an identifier of the first mobile workstation to the second mobile workstation for use as an address in a packet originating from the second mobile workstation and destined for the first mobile workstation.

14. A network as claimed in claim 12 wherein the identifier of a mobile workstation is a Home Address of the mobile workstation.

15. A network as claimed in claim 12 wherein the secure communication means provides an encrypted communications channel to the first mobile workstation and an encrypted communications channel to the second mobile workstation.

16. A network as claimed in claim 12 wherein the secure communication means comprises a first Security Association and a second Security Association.

17. A network as claimed in claim 12 wherein the gateway is arranged to detect a communications session between two mobile workstations which are connected at the external portion of the network.

18. A network as claimed in claim 12 further comprising:
means for dynamically updating an identifier of the first mobile workstation as it moves within the external portion of the network;
means for communicating the updated identifier of the first mobile workstation to the second mobile workstation; and
means for sending packets from the second mobile workstation to the first mobile workstation using the second secure communication means, wherein the packets are addressed using the updated identifier of the first mobile workstation.

19. A network as claimed in claim 18 wherein the updated identifier is a Care-of-Address.

20. A network as claimed in claim 12 wherein the network is arranged to use private addresses to communicate within the internal portion of the network and the identifier of the second workstation is a public address.

21. A method of securely routing communications between a first mobile node and a second mobile node of a network including an internal secured portion which connects, via a gateway to an external portion, comprising the steps of:
maintaining a secure communication means by which information is transferable securely to a first mobile node in the external portion of the network via the gateway and by which information is transferable securely to a second mobile node in the external portion of the network via the gateway;
sending an identifier of the second mobile node to the first mobile node using the secure communication means; and
addressing a packet sent from the first mobile node to the second mobile node using the identifier of the second mobile node and routing the packet, using the identifier of the second mobile node, from the first mobile node to the second mobile node, not necessarily via the gateway.

22. A method as claimed in claim 21 further comprising the steps of:
sending an identifier of the first mobile node to the second mobile node using the secure communication means; and
addressing a packet sent from the second mobile node to the first mobile node using the identifier of the first mobile node and routing the packet from the second mobile node to the first mobile node, not necessarily via the gateway.

23. A mobile workstation for connecting to an external portion of a network that includes an internal secured portion connected, via a gateway to the external portion, comprising:
means for using a secure communication means by which information is transferable securely from the internal portion of the network to the mobile workstation via the gateway;
means arranged to receive, via the first secure communication means, an identifier of another mobile workstation also connected to the external portion of the network; and
means for including the identifier of the other mobile workstation as an address in a packet for transmission to the other mobile workstation.

24. A virtual private network including an internal secured portion which connects, via a gateway to an external portion, the network being arranged to communicate within the internal portion of the network using private addresses and comprising:
a plurality of workstations including mobile workstations;
the gateway;
first secure communication means by which information is transferable securely to a first mobile workstation connected at the external portion of the network via the gateway and by which information is transferable securely to a second mobile workstation connected at the external portion of the network via the gateway; and
information transfer means arranged to send first security information to the first mobile workstation and second security information to the second mobile workstation using the first secure communication means, wherein the first mobile workstation uses the first security information and the second mobile workstation uses the second security information to enable a second secure communication means by which further information is transferable securely between the first mobile workstation and the second mobile workstation without passing through the gateway.

25. A virtual private network as claimed in claim 24, wherein the further information is transferable in packets using public addresses.

26. A network as claimed in claim 24, wherein the first secure communication means provides an encrypted communications channel to the first mobile workstation and an encrypted communications channel to the second mobile workstation.

27. A network as claimed in claim 24, wherein the first secure communication means comprises a first Security Association and a second Security Association.

28. A network as claimed in any one of claim 27, wherein the first Security Association is from the gateway to the first mobile workstation and the second Security Association is from the gateway to the second mobile workstation.

29. A network as claimed in claim 28 wherein the first Security Association is from the internal portion of the network to the first mobile workstation and the second Security Association is from the internal portion of the network to the second mobile workstation.

30. A network as claimed in claim 27, wherein communications using the first and second Security Associations use addresses which are private.

31. A network as claimed in claim 24 wherein the second secure communication means provides encrypted communications channels between the first and second mobile workstations.

32. A network as claimed in claim 31 wherein the first and second security information define the encryption/decryption of the encrypted communications channels.

33. A network as claimed in claim 24 wherein the second secure communication means comprises at least a third Security Association from the first mobile workstation to the second mobile workstation.

34. A network as claimed in claim 33 wherein first and second security information defines at least the third Security Association.

35. A network as claimed in claim 24, wherein at least a portion of the first security information and at least a portion of the second security information are created within the internal portion of the network.

36. A network as claimed in claim 24, wherein the gateway is arranged to detect a communications session between two mobile workstations which are connected at the external portion of the network.

37. A network as claimed in claim 24, wherein the second secure communication means is enabled by the adaptation of databases in the first and second mobile workstations.

38. A network as claimed in claim 24, further comprising:
information transfer means arranged to send, using the first secure communication means, an identifier of the second mobile workstation to the first mobile workstation for use as an address in a packet originating from the first mobile workstation and destined for the second mobile workstation.

39. A network as claimed in claim 38 wherein the identifier of the second mobile workstation is a Home Address.

40. A network as claimed in claim 38, wherein the identifier of the second mobile workstation is a public address.

41. A network as claimed in claim 24 further comprising:
means for dynamically updating an identifier of the first mobile workstation as it moves within the external portion of the network;
means for communicating the updated identifier of the first mobile workstation to the second mobile workstation; and
means for sending packets from the second mobile workstation to the first mobile workstation using the second secure communication means, wherein the packets are addressed using the updated identifier of the first mobile workstation.

42. A network as claimed in claim 41 wherein the updated identifier is a Care-of-Address.

43. A method of securing communications between a first mobile node and a second mobile node of a virtual private network including an internal secured portion which connects, via a gateway to an external portion, comprising the steps of:
communicating within the internal portion of the network using private addresses;
maintaining a first secure communication means by which information is transferable securely to the first mobile node in the external portion of the network via the gateway and by which information is transferable securely to a second mobile node in the external portion of the network via the gateway;
sending first security information to the first mobile node using the first secure communication means;
sending second security information to the second mobile node using the first secure communication means;
creating a second secure communication means in the first mobile node, using the first security information in the first mobile node and the second security information in the second mobile node; and
using the second secure communication means, and not the first secure communication means, for transferring further information between the first and second mobile nodes while they both remain in the external portion of the network.

44. A mobile workstation for connecting to a virtual private network that includes an internal secured portion connected, via a gateway to the external portion, and for communicating while in the internal portion using packet addresses which are private to the network, the mobile workstation comprising:
means for using a first secure communication means by which packets addressed to the private address of the mobile workstation are transferable securely from the internal portion of the network to the mobile workstation via the gateway;
means arranged to receive, via the first secure communication means, first security information for enabling a second secure communication means; and
means for using the enabled second secure communication means to securely receive further packets, addressed to a public address of the mobile workstation, from another mobile workstation also in the external portion of the network.

45. A mobile workstation as claimed in claim 44 further comprising a database and means for modifying the database in response to the received first security information.

46. A mobile workstation as claimed in claim 45 wherein the database includes a Security Association Database (SAD) which is modified to include a new Security Association.

47. A mobile workstation as claimed in claim 46 wherein the database includes a Security Policy database which is modified so that packets for the other mobile workstation use the new Security Association.

48. A virtual private network including an internal secured portion which connects, via a gateway to an external portion, the network being arranged to communicate within the internal portion of the network using private addresses and comprising:
a plurality of workstations including mobile workstations;
the gateway;
secure communication means by which information is transferable securely, without passing through the gateway, between a first mobile workstation connected to the external portion of the network and a second mobile workstation connected to the external portion of the network;
means for dynamically updating an identifier of the first mobile workstation as it moves within the external portion of the network;
means for communicating the updated identifier of the first mobile workstation to the second mobile workstation; and
means for sending packets from the second mobile workstation to the first mobile workstation using the secure communication means, wherein the packets are addressed using the updated identifier of the first mobile workstation and are routed without necessarily passing through the gateway.

49. A network as claimed in claim 48 wherein the updated identifier is a Care-of-Address.

50. A network as claimed in claim 48 wherein the secure communication means provides encrypted communications channels between the first and second mobile workstations.

51. A network as claimed in claim 48 wherein the secure communication means comprises a Security Association from the first mobile workstation to the second mobile workstation and a Security Association from the second mobile workstation to the first mobile workstation.

52. A network as claimed in claim 48 wherein the secure communication means is enabled by databases in the first and second mobile workstations.

53. A method of optimising the routing of secure communications between a first mobile node and a second mobile node of a network including an internal secured portion which connects, via a gateway to an external portion, comprising the steps of:
communicating within the internal portion of the network using private addresses;
creating a secure communication means by which information is transferable securely, without passing through the gateway, between a first mobile node of the external portion of the network and a second mobile node of the external portion of the network;
moving the first mobile node within the external portion of the network;
modifying an identifier of the first mobile node in response to its movement;
communicating the modified identifier of the first mobile node to the second mobile node; and
sending a packet from the second mobile node for reception by the first mobile node, without necessarily passing via the gateway, after addressing it using the updated identifier of the first mobile and securing it using the secure communication means.

54. A mobile workstation for connecting to an external portion of a network that includes an internal secured portion connected, via a gateway to the external portion, comprising:
means for communicating using private addresses when in the internal portion of the network;
means for enabling and using a secure communication means by which information is transferable securely from the mobile workstation, when in the external portion of the network, to another mobile workstation connected to the external portion of the network without passing through the gateway;
means for receiving an identifier of the other mobile workstation; and
means for sending packets, when in the external portion of the network, to the other mobile workstation using the secure communication means and the received identifier.

55. A mobile workstation as claimed in claim 54 wherein the identifier is a public address.

56. A mobile workstation as claimed in claim 55 wherein the identifier is a Home Address or a Care-of-Address.
